(19) United States
(12) Patent Application Publication
(10) Pub. No.: US 2025/0203541 A1
(43) Pub. Date: Jun. 19, 2025

(54) TIMING SERVICES OVER 4G OR 5G

(71) Applicant: Telefonaktiebolaget LM Ericsson (publ), Stockholm (SE)

(72) Inventors: Stefano Ruffini, Rome (IT); Mårten Wahlström, Hägersten (SE); Marilet De Andrade Jardim, Kista (SE); Magnus Sandgren, Staffanstorp (SE)

(21) Appl. No.: 18/847,741

(22) PCT Filed: Mar. 17, 2023
(86) PCT No.: PCT/IB2023/052656

§ 371 Date: Sep. 17, 2024

Related U.S. Application Data
(60) Provisional application No. 63/320,841, filed on Mar. 17, 2022.

(51) Int. Cl. H04W 56/00; H04W 24/04; H04W 24/10

(52) U.S. Cl. CPC H04W 56/001; H04W 24/04; H04W 24/10

(57) ABSTRACT

Methods, apparatuses, and computer readable media are disclosed for configuring a Time Management Function (TMF) to select a Time Distribution Alternative (TDA). The method includes configuring a set of TDAs. The method further includes transmitting a set of report requests with respect to the set of TDAs to an end station or a Timing Device (TD), and receiving a set of measurement reports with respect to the set of TDAs, from the end station or from the TD. Each of the set of measurement reports being specific TDA with input conditions. The method further includes evaluating the set of TDAs based on one or more requirements and the set of measurement reports, and selecting a currently most appropriate TDA among the set of TDAs based on results of the evaluating step and one or more conditions that may relate to the input conditions.

### RELATED APPLICATIONS

This application claims the benefit of provisional patent application Ser. No. 63/320,841, filed Mar. 17, 2022, the disclosure of which is hereby incorporated herein by reference in its entirety.

### TECHNICAL FIELD

The present disclosure relates to methods, apparatuses, and systems for time synchronization in cellular networks.

### BACKGROUND

Reliable time synchronization is required by several applications, which are often parts of the critical infrastructure. Coordinated Universal Time (UTC) traceability is often required for those applications. Examples of the applications include smart grid, financial, automotive, media broadcast, and industrial automation.

The followings are some issues that need to be addressed for the applications: (a) redundancy and protection against jamming/spoofing of the local GNSS receiver, (b) Global Navigation Satellite System (GNSS) Satellite visibility (not visible inside a building or in urban canyons), and (c) low accuracy achieved by traditional methods such as Network Time Protocol (NTP) over Internet Protocol (IP).

Solutions to address those issues are proposed in relevant standards. For example, Third Generation Partnership Project (3GPP) defines the solutions where timing is carried over Fifth Generation (5G) radio and used in one of the following two options (see e.g., TSG SA Meeting #SP-94E, “Study on 5G Timing Resiliency and TSC & URLLC enhancements,” SP-211634, December 2021): (a) as a back up to a primary application local GNSS synchronization source, (b) as a primary source where GNSS is not available as a local sync source for the application. FIG. 1 (FIGS. 4.2-1 of 3GPP TR 22.878 V18.2.0 (2021 December), “Example of time resilience use case for financial markets”) illustrates an example for 5G system (5GS) supporting timing for the Financial sector. FIG. 2 (FIGS. 4.2-2 of 3GPP TR 22.878 V18.2.0 (2021 December), “UTC (k) time distribution with 5G system indicating the traceability chain”) illustrates another example for 5G system supporting timing for the Financial sector.

Requirements from 3GPP TS 22.261 V18.5.0 (2021 December) for some relevant use cases (Smart grid, financial) are stated in the tables in FIG. 3 and FIG. 4. That is, FIG. 3 reproduces ‘Table 7.8-2: Timing resiliency accuracy Key Performance Indicators (KPIs) for members or participants of a trading venue’ of 3GPP TS 22.261 V18.5.0 (2021 December), which discloses requirements for financial use case. FIG. 4 reproduces ‘Table 7.8-1: Timing resiliency performance requirements for 5G system’ of the same 3GPP standard, which discloses requirements for smart grid use case.

3GPP TS 23.501 V17.3.0 (2021 December) already defines building blocks to make Fifth Generation System (5GS) as a “transparent” sync box, or as sync master for connected applications. For the sync master aspect, however, sync service framework has not been fully defined. Further details on what is currently specified by 23.501 V17.3.0 (2021 December) is discussed below.

### Synchronization Solution Specified in 3GPP TS 23.501 V17.3.0 (2021 December)

In TS 23.501 V17.3.0 (2021 December), clauses 4.4.8, 5.27.1, and 5.28.3 give a background on the way that Time Sensitive Networking (TSN) and a more general case of Time Sensitive Communications (TSC) can be supported in the 5GS. This may be important because time synchronization service provided by 5G has been built based on this model.

FIG. 5 illustrates that 5GS modeled as a node. Note that the present disclosure is not limited to the 5GS. Embodiments of the present disclosure are applicable to other network system like Fourth Generation System, 4GS, or future systems still to be defined, e.g., 6G. TSC and Time Synchronization Function (TSCTSF) is a new function added to the control plane in Rel-17. As illustrated in FIG. 5, the 5GS can act as a TSN bridge or a TSC node by using translators at the user plane such as the Device-side TSC Translator (DS-TT) located at UE, and the Network-side TSC translator (NW-TT) located at the UPF, and translator/coordinator at the control plane (using a TSN Application Function (AF) for TSN or using the TSCTSF for TSC), such that the 5GS can interoperate with other TSN/TSC nodes and be able to handle the Quality of Service (QOS) required and Time Synchronization related signaling. The core network nodes shown in FIG. 5—an Application Function (AF), a Network Exposure Function (NEF), a Policy Control Function (PCF), a Session Management Function (SMF), an Access and Mobility Management Function (AMF), a User Plane Function (UPF) —are further explained below and shown in FIG. 10 and FIG. 11.

The support for a time synchronization service has been specified in 3GPP TS 23.501 V17.3.0 (2021 December) (clause 5.27.1) and in 3GPP TS 23.502 V17.3.0 (2021 December) (clause 4.15.9). A series of parameters are exchanged between the 5GS and an TSCTSF/TSN AF in order to negotiate the requirements for a time sensitive communication and be able to expose the 5GS time synchronization capabilities toward AF and obtain time synchronization requirements from AF.

The AF may request service with specific requirements that can be used to configure the time synchronization distribution to targeted User Equipments (UEs). Among the requirements, the AF may provide the required 5G error budget/accuracy. TSCTSF calculates the available error budget for the Uu interface segment and provides it to Radio Access Network (RAN), as described in clause 5.27.1.9 of 3GPP TS 23.501 V17.3.0 (2021 December) and clause 4.15.9.4 of 3GPP TS 23.502 V17.3.0 (2021 December). Upon reception of the error budget, RAN may decide to use a delay compensation method to achieve the requested accuracy.

TSCTSF (or TSN AF) configures the port states (master, slave, etc.) based on local configuration or the results of the Best Master Clock algorithm running in NW-TT and shared with TSCTSF or TSN AF. The AF may request to use the “5G access stratum” as a time synchronization distribution method towards the connected nodes (i.e., according to 3GPP terminology, the 5GS is the synchronization master towards connected applications, and the 5G system is not a part of a Precision Time Protocol (PTP) network; the timing is therefore provided via a dedicated timing interface, not necessarily via a PTP interface).

TSCTSF (or TSN AF) configures clock parameters provided by AF in case the 5GS acts as a Grand-Master (GM) clock (GM clock functionality may be at DS-TT or NW-TT) and the time distribution method is access stratum.

The 5GS is configured to support one or multiple PTP instances (operating in different PTP domains) and to operate in one of the following modes (if supported) for each PTP instance: 1) as time-aware system as described in Institute of Electrical and Electronics Engineers (IEEE) standard 802.1AS, as Boundary Clock as described in one of the relevant IEEE standard 1588 profiles, as peer-to-peer Transparent Clock as described in one of the relevant IEEE standard 1588 profiles, and as end-to-end Transparent Clock as described in one of the relevant IEEE standard 1588. The later three are provisioned by a profile supported in the 3GPP Rel-17 specification.

There are two concurrent synchronization processes in 5G system: 5GS synchronization and TSC synchronization. TSC synchronization provides synchronization service to the TSC network. 5GS synchronization provides a 5G reference clock for 5GS internal synchronization where a New Radio Base Station (gNB), the NW-TT and the DS-TT are all synchronized with the 5G reference clock.

FIG. 6 reproduces FIG. 5.27.1-1 of 3GPP TS 23.501 V17.3.0 (2021 December) where 5G system is modeled as a PTP instance for supporting time synchronization. As illustrated, depending on the location of the GM, the TT receiving (g)PTP messages will generate an ingress timestamp (TSi) based on the 5GS reference clock for every (g)PTP message entering the 5GS, and embeds the timestamp within that (g)PTP message. Furthermore, the (g)PTP message is forwarded to all DS-TTs (if downlink), or to NW-TT and all DS-TTs (if uplink). Then, the destination TT generates an egress timestamp (TSe) for the (g)PTP message. The difference between TSi and TSe is the residence time this (g)PTP message has spent within the 5GS. The destination TT also modifies the TSN/TSC timing information received from gPTP messages based on the calculated 5GS residence time and sends it out to the next node.

The solution specified in TS 23.501 V17.3.0 (2021 December) is related to the problem addressed by the present disclosure, for the case when the 5G system itself becomes the timing master for the connected applications (via the DS-TT).

### New 3GPP Study Item on Timing Resiliency

In 3GPP SA2 Rel-18, a new study item started in February 2022 including the support for 5G timing resiliency, where the 5G system may provide a back-up timing source for an application in case its local primary timing source has failed. Specific objectives have been approved in SP-211634 (TSG SA Meeting #SP-94E, “Study on 5G Timing Resiliency and TSC & URLLC enhancements,” SP-211634, December 2021), and the work progress will be reflected in TR 23.700-25 V0.1.0 (2022 March 4). It is assumed that the 5G support for timing resiliency will be applied by reusing the time synchronization service already specified in Rel-17.

When timing is provided by the 5GS, the main Requirement for 5GS is to be robust against failure (especially against same failure that may impact the “local GNSS”). Up to 24 hours “Time holdover” is specified.

### Assisted Partial Timing Support

Another important background and state of the art related information concerns the concept of assisted timing support in G.8271.2 by International Telecommunication Union Telecommunication Standardization Sector (ITU-T) (“Network limits for time synchronization in packet networks with partial timing support from the network”).

Distribution of a reference timing signal can be done via the IEEE1588 PTP. Highest accuracy can be achieved when all network elements along the path (switches and/or routers) are able to terminate and regenerate the PTP messages (i.e., via boundary clock or transparent clock functionality). When the transport network elements do not support the processing of PTP, the timing reference is distributed in so called “partial timing support” delivering PTP over IP over the network. This leads to some degradation of the timing reference due to packet delay variation added by the network.

One special set up, “assisted partial timing support,” has been defined by ITU-T where this “noisy” reference is only used as back-up to a local accurate reference (typically based on a GNSS receiver). In normal operation, the accurate local reference is used to “calibrate” the noisy PTP reference. When the local reference is lost, assuming the network where PTP is carried is within certain Packet delay variation limits, the PTP reference can be used as a secondary reference over limited time period (e.g., 1 day).

### SUMMARY

Methods, apparatuses, and computer readable media are disclosed for configuring a Time Management Function (TMF) to select a Time Distribution Alternative (TDA). The method includes configuring a set of TDAs. The method further includes transmitting a set of report requests with respect to the set of TDAs to an end station or a Timing Device (TD), and receiving a set of measurement reports with respect to the set of TDAs, from the end station or from the TD. Each of the set of measurement reports being specific TDA with input conditions. The method further includes evaluating the set of TDAs based on one or more requirements and the set of measurement reports, and selecting a currently most appropriate TDA among the set of TDAs based on results of the evaluating step and one or more conditions that may relate to the input conditions. Certain embodiments may provide one or more of the following technical advantages. First, there will be a reduced impact on the 5G system using the disclosed subject matter, e.g., no additional requirements on the existing synchronization solutions. Second, there will be a multiplying in the range of service opportunities in the area addressing new types of applications. Third, 5G system service performance is improved.

In some embodiments, the method includes receiving the input conditions to be associated with a specific TDA feedback measurement and/or evaluation, and repeating the foregoing steps. In some embodiments, the method further includes training a system and collecting sufficiently different TDAs with related measurement reports. In some embodiments, the method includes determining or obtaining one or more of required Fourth Generation System, 4GS, and/or Fifth Generation System, 5GS, backup performances. In some embodiments, the one or more of required 4GS and/or 5GS backup performances include a stability of a timing in the 4GS and/or the 5GS or an offset of the timing in the 4GS and/or the 5GS. In some embodiments, the report request includes a measurement period (e.g., start and stop time) and/or a reporting format. In some embodiments, the measurement report includes one or more of (i) a measurement serving network stability towards a local reference (statistical), (ii) timing offset information, (iii) characteristics of the local reference like stability, (iv) a measurement start time and a measurement stop time, and/or (v) measurement confidence. In some embodiments, the one or more input conditions to evaluate the set of TDAs include a back-up performance, a position of the end station, or Radio Frequency (RF) channel characteristics. In some embodiments, the one or more conditions to select the currently most appropriate TDA among the set of TDAs are (a) required 4GS/5GS backup performance (e.g., stability or timing offset), (b) conditions, (c) RF resource availability, and/or (d) energy efficiency constraints. In some embodiments, the method further includes reporting to an external network when the required 4GS/5GS backup performances are not or cannot be met by any TDA in the set of TDAs after the set of TDAs are evaluated. In some embodiments, the external network is a client network to which the 4GS/5GS will provide the timing service via an Application Function (AF). In some embodiments, the AF sends a request for time synchronization service including one or more of (a) a required level of stability, (b) a required error budget, and/or (c) required UTC traceability. In some embodiments, the end station is an end application and the TD is a User Equipment (UE).

In another aspect, a method is performed by an end station or by a TD for performing a measurement related to a timing of a 4GS, and/or a 5GS. The method includes receiving from a TMF a set of report requests with respect to the set of TDAs. The method further includes performing measurements of a set of performances related to the set of report requests with respect to the set of TDAs, transmitting to the TMF a set of measurement reports on the measurements of the set of performances with respect to the set of TDAs, and receiving a currently most appropriate TDA among the set of TDAs when a backup service is needed. In some embodiments, the measurements of the set of performances include one or more of (i) a stability of the timing in the 5GS or (ii) an offset of the timing in the 5GS. In some embodiments, the end station is an end application and the TD is a User Equipment, UE.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of a 5G system (5GS) supporting timing for the financial sector taken from FIGS. 4.2-1 of 3GPP TR 22.878 V18.2.0 (2021 December), “Example of time resilience use case for financial markets”.

FIG. 2 illustrates another example of a 5G system supporting timing for the financial sector taken from FIGS. 4.2-2 of 3GPP TR 22.878 V18.2.0 (2021 December), “UTC (k) time distribution with 5G system indicating the traceability chain”.

FIG. 3 illustrates requirements for an example financial sector use case taken from Table 7.8-2 of 3GPP TS 22.261 V18.5.0 (2021 December), “Timing resiliency accuracy Key Performance Indicators (KPIs) for members or participants of a trading venue.”

FIG. 4 illustrates requirements for an example smart grid use case from Table 7.8-1 of 3GPP TS 22.261 V18.5.0 (2021 December), “Timing resiliency performance requirements for 5G system.”

FIG. 5 illustrates an example of a 5G system (5GS) node.

FIG. 6 illustrates a 5G system modeled as a Precision Time Protocol (PTP) instance for supporting time synchronization taken from FIG. 5.27.1-1 of 3GPP TS 23.501 V17.3.0 (2021 December).

FIG. 7 is a copy of by ITU-T G.8271.2, FIG. 1, “Reference model for network limits for assisted partial timing support.”

FIG. 8 illustrates an example process for selecting a most appropriate Time Distribution Alternatives (TDA) among a set of TDAS.

FIG. 9 illustrates an example of a cellular communications system in which embodiments of the present disclosure may be implemented.

FIG. 10 illustrates a wireless communication system represented as a 5G network architecture composed of core Network Functions (NFs), where interaction between any two NFs is represented by a point-to-point reference point/interface.

FIG. 11 illustrates a 5G network architecture using service-based interfaces between the NFs in the control plane (CP), instead of the point-to-point reference points/interfaces used in the 5G network architecture of FIG. 10.

FIG. 12 illustrates an example arrangement for status feedback.

FIG. 13 illustrates an example sequence of actions for a status feedback arrangement.

FIG. 14 illustrates aspects of the instant disclosure applied to a financial services application.

FIG. 15 is a schematic block diagram of a radio access node according to some embodiments of the present disclosure.

FIG. 16 is a schematic block diagram of a radio access node according to some embodiments of the present disclosure.

FIG. 17 is another schematic block diagram of a radio access node according to some embodiments of the present disclosure.

FIG. 18 is a schematic block diagram of a wireless communication device according to some embodiments of the present disclosure.

FIG. 19 is another schematic block diagram of a wireless communication device according to some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like. Most core network nodes are in the control plane with control and management tasks, and just UPF is in the user plane with packet forwarding functionalities.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is often used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). The following solutions are currently proposed in relevant standards (or under definition), for example, TSG SA Meeting #SP-94E, “Study on 5G Timing Resiliency and TSC & URLLC enhancements,” SP-211634, December 2021, and 3GPP TS 22.261 V18.5.0 (2021 December). 3GPP may specify a solution where timing is carried over 3GPP radio and used in one of the following two options: (a) as a back up to a local GNSS (b) as a primary source where GNSS is not available (e.g., inside a building).

Especially for some application with stringent requirements (e.g., 250 ns in some Smart Grid configurations), the 5GS (or the 4GS) would need to implement a very costly timing solution (practically unfeasible).

Some of the related issues are presented below.

The distribution of time through the 5GS (or the 4GS) includes several components in the path, each adding to the total 5GS timing errors like synchronization source, distribution to the BS (Base Station) input, internal BS errors, air interface related errors and internal UE errors.

As an example, in 3GPP Rel 17 RAN work, there has been a breakdown assumption of the 5GS budget into sub-components to understand air interface budget and to define methods and requirements for Radio Frequency (RF) air propagation delay compensation as a part of time distribution within the 5GS (time defined at Base Station (BS) antenna). The budget assumptions made there will be well-above, e.g., mentioned 250 ns (e.g., the allowed budget for a new air interface propagation delay method alone could be up to 275 ns).

Also, for time distribution in wide areas, due to variety of deployment characteristics, products and radio environments, one could foresee large variations in possibilities to reach a certain absolute time accuracy, but also in addition to above-mentioned use cases, one could foresee that additional use cases, by solutions and systems proposed in this present disclosure, could be benefitted from existing networks without large complexity and cost impact. These options have never been discussed in 3GPP and, indeed, could allow to reduce the impact on 5G as well as enable important business cases for network operators.

There are, proposed herein, various embodiments which address one or more of the issues disclosed herein.

Certain aspects of the present disclosure and their embodiments may provide solutions to the aforementioned or other challenges. It is proposed to address additional time services that can be offered by 5G (or in general, a suitable radio technology like 4G or later 6G), as follows.

First, assisted time service support. Only 5G phase/frequency is used, to be combined with the local GNSS. When GNSS is lost, the accurate frequency and/or phase from 5G radio is used to control holdover of a local oscillator. Many of the errors in the 5GS are likely to be static over time and some dynamic parts can be filtered out due to stable oscillators, the offset and the stability of the 5GS timing when used during holdover, could then be characterized when local GNSS is operational. In an additional embodiment, the characterization of the 5GS time can be used as feedback to dynamically (based on present requirements, conditions, or etc.) configure and select the currently most appropriate time distribution alternative (TDA) within the 5GS among a set of alternatives. The TDA may refer to two alternatives: first, frequencies or phases that the 5G network delivers to the client network, and the client network makes the evaluation and compensation; second, the client network's time is provided to the 5G network and the 5G network makes the evaluation and delivers a compensated time. The TDA may be various combinations of: different time distribution paths (cellular and wired), time stamp filtering algorithms, Propagation Delay Compensation (PDC) methods, RF time distribution alternatives, RF frequency bands, GM clock sources, UEs, this to secure sufficient serving network stability when acting as back up. Additionally, a feedback or status report towards the external network (client network) via UE application or end station connected to it which can be provided directly if available at those devices or UE, and via AF which can be provided as a status report. The status report containing: Boolean parameter indicating whether the requirements for the service (requested originally by AF, as per Rel-17 TS 23.501 clause 5.27.1 and TS 23.502 clause 4.15.9, and including error budget) such as error budget, UTC traceability (as proposed in Rel-18 TR 23.700-25, Solution #1), and a new requirement that can be added to the AF request such as stability. Optionally, when any of the requirements is not achieved, the status report may also include the current value of the parameter.

Second, verification (by a financial authority or a Legally recognized verification authority) that a trust time stamp (e.g., financial transactions or similar application) is correct. The requirement for financial transaction is made by the financial authority, and it is the financial authority that is interested in securing the trust of time stamps. The transaction is using a time service delivered over a fixed internet connection (PTP or NTP), but the time stamp is then verified by sending the reference of the transaction across the time stamping UE and via the mobile network. The DS-TT compares the financial transaction timestamp with the 5GS time reference. The DS-TT may be called as a Time Device (TD), for simplicity, in other parts of the present disclosure. The result is communicated to a 5G server (e.g., any network node in the RAN network or any network function in the core network) that is used for this financial trust service or the service for verification of the timestamp.

Third, simplified sync as a service. Only phase is distributed in the system over the radio to adjust a local course time reference (typically NTP based). There is no need to distribute time information. Only alignment with UTC of the System Frame Number (SFN) is required in the system.

As a part of the WI Study on timing resiliency, 3GPP is currently studying and focusing on two basic services that can be provided by a 5G system: (a) a timing reference back-up to local GNSS and (b) a primary reference. 3GPP is currently focusing on applications such as financial servers and power system devices. The 5G system may comprise 5G Access Network (AN), 5G Core Network, and User Equipments (UEs), as defined in 3GPP TS 23.501 V17.3.0 (2021 December 23).

These services, in the way they are being defined in some cases, may result in significant impacts for the 5G system and possibly result in unfeasible services (e.g., due to too stringent requirements).

Solutions and systems proposed in the present disclosure are directed to enable new timing services that could be defined in addition to those already discussed in 3GPP. The new timing services could allow a richer offer as well as addressing use cases with potentially lower impact to the 5G system. As a part of the solutions proposed in the present disclosure, one of the solutions would also allow to improve the 5G sync service performance.

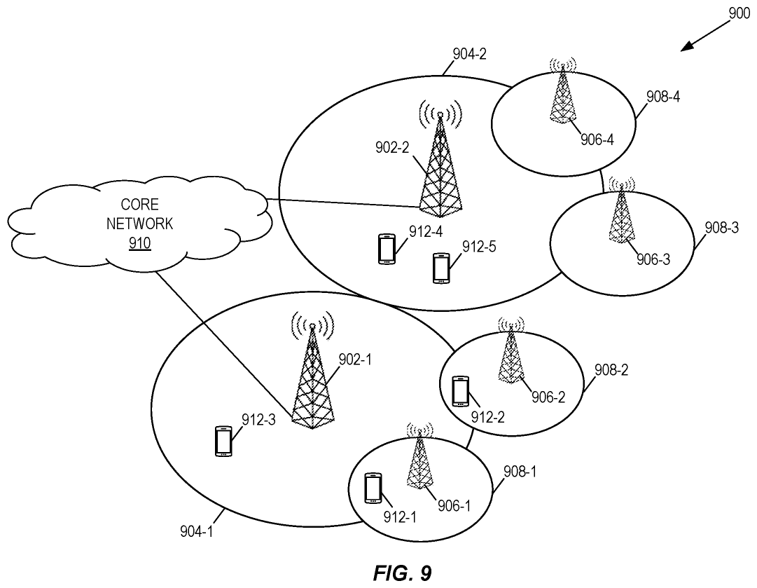

FIG. 9 illustrates one example of a cellular communications system 900 in which embodiments of the present disclosure may be implemented. In the embodiments described herein, the cellular communications system 900 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 902-1 and 902-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 904-1 and 904-2. The base stations 902-1 and 902-2 are generally referred to herein collectively as base stations 902 and individually as base station 902. Likewise, the (macro) cells 904-1 and 904-2 are generally referred to herein collectively as (macro) cells 904 and individually as (macro) cell 904. The RAN may also include a number of low power nodes 906-1 through 906-4 controlling corresponding small cells 908-1 through 908-4. The low power nodes 906-1 through 906-4 can be small base stations (such as pico or femto base stations) or RRHs, or the like. Notably, while not illustrated, one or more of the small cells 908-1 through 908-4 may alternatively be provided by the base stations 902. The low power nodes 906-1 through 906-4 are generally referred to herein collectively as low power nodes 906 and individually as low power node 906. Likewise, the small cells 908-1 through 908-4 are generally referred to herein collectively as small cells 908 and individually as small cell 908. The cellular communications system 900 also includes a core network 910, which in the 5G System (5GS) is referred to as the 5GC. The base stations 902 (and optionally the low power nodes 906) are connected to the core network 910.

The base stations 902 and the low power nodes 906 provide service to wireless communication devices 912-1 through 912-5 in the corresponding cells 904 and 908. The wireless communication devices 912-1 through 912-5 are generally referred to herein collectively as wireless communication devices 912 and individually as wireless communication device 912. In the following description, the wireless communication devices 912 are oftentimes UEs, but the present disclosure is not limited thereto.

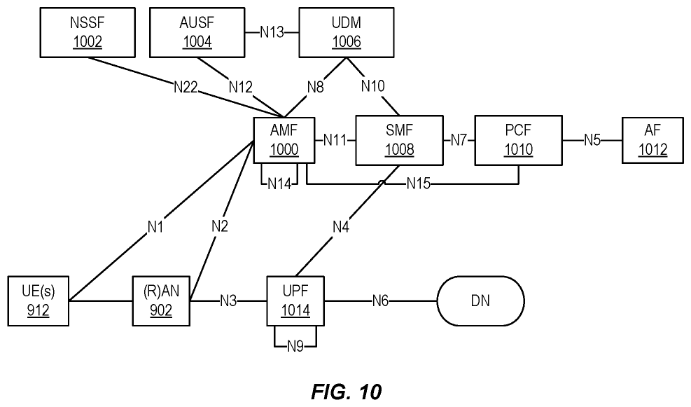

FIG. 10 illustrates a wireless communication system represented as a 5G network architecture composed of core Network Functions (NFs), where interaction between any two NFs is represented by a point-to-point reference point/interface. FIG. 10 can be viewed as one particular implementation of the system 900 of FIG. 9.

Seen from the access side the 5G network architecture shown in FIG. 10 comprises a plurality of UEs 912 connected to either a RAN 902 or an Access Network (AN) as well as an AMF 1000. Typically, the R(AN) 902 comprises base stations, e.g., such as eNBs or gNBs or similar. Seen from the core network side, the 5GC NFs shown in FIG. 10 include a NSSF 1002, an AUSF 1004, a UDM 1006, the AMF 1000, a SMF 1008, a PCF 1010, and an Application Function (AF) 1012.

Reference point representations of the 5G network architecture are used to develop detailed call flows in the normative standardization. The N1 reference point is defined to carry signaling between the UE 912 and AMF 1000. The reference points for connecting between the AN 902 and AMF 1000 and between the AN 902 and UPF 1014 are defined as N2 and N3, respectively. There is a reference point, N11, between the AMF 1000 and SMF 1008, which implies that the SMF 1008 is at least partly controlled by the AMF 1000. N4 is used by the SMF 1008 and UPF 1014 so that the UPF 1014 can be set using the control signal generated by the SMF 1008, and the UPF 1014 can report its state to the SMF 1008. N9 is the reference point for the connection between different UPFs 1014, and N14 is the reference point connecting between different AMFs 1000, respectively. N15 and N7 are defined since the PCF 1010 applies policy to the AMF 1000 and SMF 1008, respectively. N12 is required for the AMF 1000 to perform authentication of the UE 912. N8 and N10 are defined because the subscription data of the UE 912 is required for the AMF 1000 and SMF 1008.

The 5GC network aims at separating UP and CP. The UP carries user traffic while the CP carries signaling in the network. In FIG. 10, the UPF 1014 is in the UP and all other NFs, i.e., the AMF 1000, SMF 1008, PCF 1010, AF 1012, NSSF 1002, AUSF 1004, and UDM 1006, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 1000 and SMF 1008 are independent functions in the CP. Separated AMF 1000 and SMF 1008 allow independent evolution and scaling. Other CP functions like the PCF 1010 and AUSF 1004 can be separated as shown in FIG. 10. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

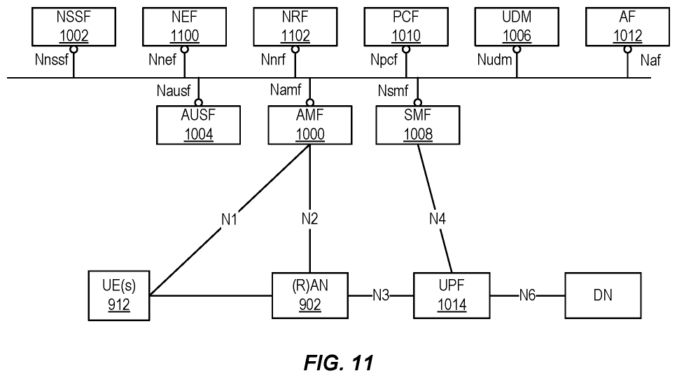

FIG. 11 illustrates a 5G network architecture using service-based interfaces between the NFs in the CP, instead of the point-to-point reference points/interfaces used in the 5G network architecture of FIG. 10. However, the NFs described above with reference to FIG. 10 correspond to the NFs shown in FIG. 11. The service(s) etc. that a NF provides to other authorized NFs can be exposed to the authorized NFs through the service-based interface. In FIG. 11 the service based interfaces are indicated by the letter “N” followed by the name of the NF, e.g., Namf for the service based interface of the AMF 1000 and Nsmf for the service based interface of the SMF 1008, etc. The NEF 1100 and the NRF 1102 in FIG. 11 are not shown in FIG. 10 discussed above. However, it should be clarified that all NFs depicted in FIG. 10 can interact with the NEF 1100 and the NRF 1102 of FIG. 11 as necessary, though not explicitly indicated in FIG. 10.

Some properties of the NFs shown in FIGS. 10 and 11 may be described in the following manner. The AMF 1000 provides UE-based authentication, authorization, mobility management, etc. A UE 912 even using multiple access technologies is basically connected to a single AMF 1000 because the AMF 1000 is independent of the access technologies. The SMF 1008 is responsible for session management and allocates Internet Protocol (IP) addresses to UEs. It also selects and controls the UPF 1014 for data transfer. If a UE 912 has multiple sessions, different SMFs 1008 may be allocated to each session to manage them individually and possibly provide different functionalities per session. The AF 1012 provides information on the packet flow to the PCF 1010 responsible for policy control in order to support QoS. Based on the information, the PCF 1010 determines policies about mobility and session management to make the AMF 1000 and SMF 1008 operate properly. The AUSF 1004 supports authentication function for UEs or similar and thus stores data for authentication of UEs or similar while the UDM 1006 stores subscription data of the UE 912. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

### Assisted Time Service Support

The solution is divided between the serving network (e.g., the 4G network or the 5G Network) and the client network, which has a need of reliable time. The basic principle for the assisted time service is that the client network has a local time solution providing time information for a critical service, such as monitoring a power grid or time stamping critical events. Such local time solutions may suffer from availability issues, for example, using time locally from GNSS systems.

To increase the availability of time information, the serving network can provide a backup solution. The present disclosure is directed to the fact that the local time of the client network is correct and has sufficient accuracy for the client network as long as its primary time reference is functional. In case the local time reference fails, the local clock can continue to tick with high accuracy if it is provided with a highly stable frequency or phase information from the serving network.

This is inspired by the basic principle outlined in ITU-T G.8275.2 Assisted Partial Timing Support (APTS) option. The differences between the basic principle outlined in ITU-T G.8275.2 APTS option and the solutions proposed in the present disclosure are the followings.

First, for the APTS solution of ITU-T G.8275.2, the serving network is a PTP over IP over cable solution. In the present disclosure, examples of the serving network are (a) the 5G Network System including the 5G Access Network (AN), the 5G Core Network, and the UE and (b) the 4G network including the EPC, the EUTRAN, and the UE.

Second, the APTS solution is limited to support GNSS with the PTP over IP connection, and only phase information from the PTP over IP connection is used. In the present disclosure, the support is provided over radio and via a more accurate and stable reference (if compared with PTP/IP in partial timing support). Also, in the present disclosure, it can be used to support any type of local timing reference.

Third, for the APTS solution, there is a tight integration between the application running both the GNSS time synchronization and the PTP over IP connection, and there is no service interface between the GNSS time and the PTP time networks. In the present disclosure, a clear client network/serving network separation is made since the 5G Network must be able to offer a backup as a service. The serving network may provide one or several local service interfaces, or one service interface with one or several time and service information signals. As an option, information from the client network to the serving network could enable the serving network to take a decision and always provide synchronization to the client network.

The same principle can also be applied to the Fourth Generation (4G) Long Term Evolution (LTE) network.

There are optional ways for the 5G Network to provide a stable phase or frequency interface.

First, in case 1, it can provide a stable time/phase by utilizing the time synchronization capability of the gNodeB (or eNodeB), distribution time to the UE, which can provide an assisting time interface to the client network. The absolute time accuracy of the serving network can be less than the required time accuracy by the client network. The requirement on the serving network is that the stability of the phase of the serving network is better than the required time accuracy of the client network.

Second, in case 2, it can provide a stable frequency by utilizing a highly accurate frequency/phase delivered by the gNodeB (or the eNodeB) to the UE, which can provide a stable frequency/phase interface to the client network. The serving network frequency does not contain time phase information. The serving network frequency contains only frequency information, and the phase that an oscillating signal inherently has. The requirement on the serving network is that the stability of the phase of the serving network is better than the required time accuracy of the client network.

There will be a service delivery interface between the serving network and the client network.

This interface will contain, for both of the case 1 and the case 2 (which are described above), time and stability information. The serving network can either provide stability information, or, on a request from the client network, acknowledge the required stability.

In case for the acknowledge procedure alternative, the serving network will inform the client network if the stability has degraded outside the acknowledged stability commitment.

It is assumed the client network monitors its primary time reference and when the client network no longer trusts the primary time reference takes a decision to use the serving network's backup signal to advance its clock.

For the case 1, it is assumed that the client network has calculated the time difference between its primary time reference and the backup time provided by the serving network in an earlier phase when it trusted its primary time reference, and when using the serving network time, the client network compensates for the difference.

An alternative for calculating the time difference is that the client network provides its time information to the serving network as long as it trusts its primary time reference, and that the serving network calculates the difference and compensates the time information the serving network delivers. This compensation can be done locally close to the service interface, since with this method, the time that is delivered will be locally adapted to the client network.

For the case 2, there is no need to exchange time information across the client server interface. The serving network must assess its stability. This can be done by the serving network itself by using built in high stability oscillators in the gNodeB/eNodeB that has an intrinsic stability better that the required client network stability, or by utilizing a time interface from the client network to the serving network to monitor the stability of its own frequency/phase.

### Stability/Time Offset Status Feedback

During a normal operation when the primary local time reference is available, the primary local time reference is used as a reference for comparing towards the serving network's time and the characteristics of the serving network time with respect to stability and time offset are analyzed.

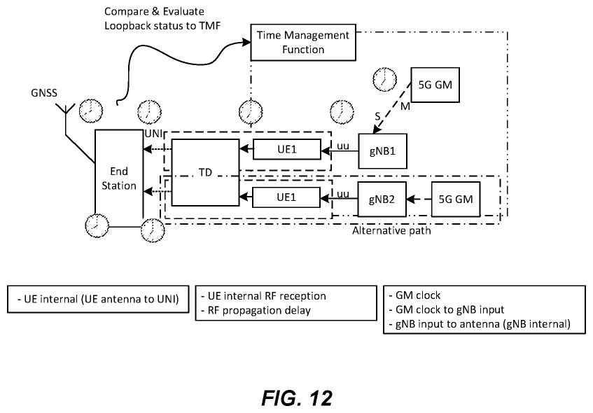

FIG. 12 is an example of arrangement for status feedback. As illustrated, there could be two alternative methods for this. First, the end station (e.g., end application) receives both the serving network's time/phase/frequency information and the client network's primary local time reference (e.g., GNSS) and determines an offset and stability when a local reference is available. Second, the UE/Timing Device (TD or DS-TT) receives local time information from the client network or the end station (e.g., the end application) and performs the analysis.

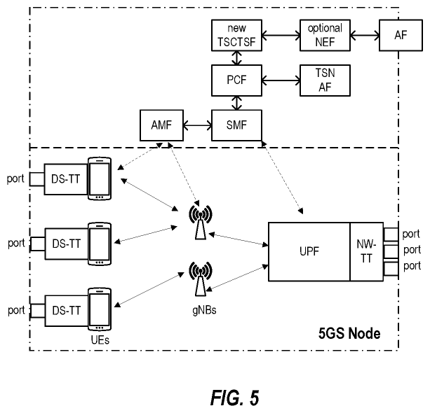

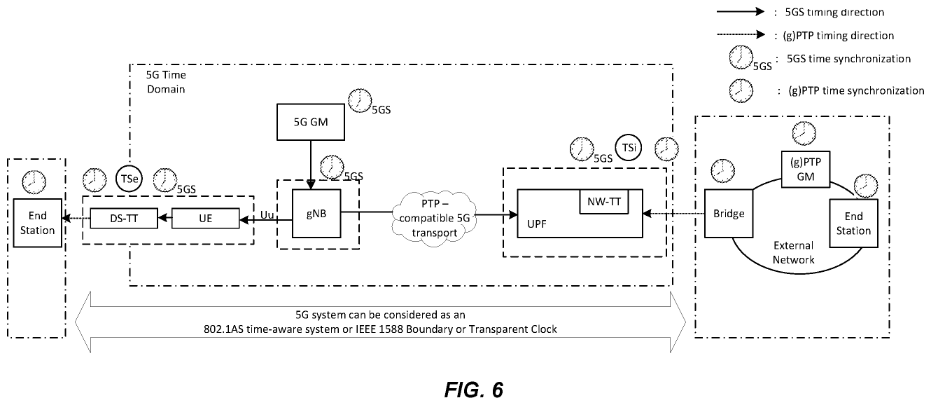

As illustrated in FIG. 12, the result of the analysis is sent as loopback information to a centralized Time Management Function (TMF), which can combine these data with data received from multiple UEs potentially connected to same customer/application or other customers/applications. For example, the TMF may be implemented in any functions showed in FIG. 5, FIG. 10, and FIG. 11. In other words, the TMF may be implemented in gNB, in an Application Function (AF), a Network Exposure Function (NEF), a Policy Control Function (PCF), a Session Management Function (SMF), an Access and Mobility Management Function (AMF), a User Plane Function (UPF), a TSC and Time Synchronization Function (TSCTSF), a Network Data Analytics Function (NWDAF). If the 4GS is used, the TMF may be implemented in any functions like MME, PGW, and PCRF.

Based on loopback information and required backup performance (e.g. stability or offset), the TMF by means of proper computations, such as Artificial Intelligence (AI) algorithms (e.g., comparing performance within a certain area that is served by a specific Grandmaster vs., areas served by a different grandmaster, etc.; this may involve knowledge from a sync management system (e.g., from TSCTSF), that could be shared with the gNB), evaluates and compares performance when using different Time Distribution Alternatives (TDA) based on various combinations of e.g.: (a) different time distribution paths (both cellular and wired distribution paths), (b) time stamp filtering algorithms, (c) RF Propagation Delay Compensation (PDC) methods, (d) RF time distribution alternatives (e.g. unicast or broadcast), (e) RF frequency bands, (f) GM clock sources, or (g) UEs, to secure sufficient serving network's stability by using most appropriate TDA when acting as a backup.

Based on one or parameters, such as dynamically-dependent required back up performance (dependent end application needs like related to a required back-up duration), the TMF may select the currently most appropriate TDA among a set of TDAS.

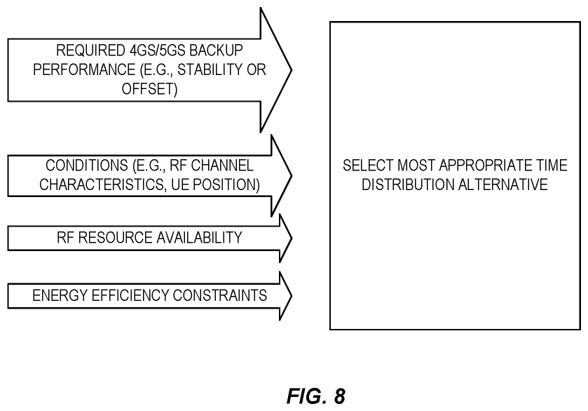

The most appropriate TDA may be dependent on the conditions, i.e., during certain RF condition one TDA may be most appropriate while, during other conditions, another TDA may be most appropriate. Other input conditions could be the UE's positions. Based on TDA assessment over time during different experienced conditions, the TMF may learn and include those conditions in the above-described TDA determination. Since the performance of a TDA is also dependent the conditions (RF conditions, UE positions), such information may also be added and associated to a TDA evaluation in the training process. The conditions are then also used as one of the inputs in the selection process, for example, as shown in FIG. 8. The loopback information valid for a specific tested TDA configuration is dependent on the actual conditions present during the measurement and the conditions associated are obtained and included by the TMF as part of the TDA assessment.

The most appropriate alternative at a specific time must not necessarily be the most stable or accurate, as long as the appropriate alternative meets the requirements. FIG. 8 illustrates a process for selecting the most appropriate TDA among a set of TDA. As illustrated in FIG. 8, the following input parameters are examples that could be considered: (a) required 4GS/5GS backup performance (e.g., stability or timing offset), (b) conditions (e.g., RF channel characteristics, UE position), (c) RF resource availability, and/or (d) energy efficiency constraints.

That is, the following aspects could also be considered in the selection process.

First, using RF resources over the Uu interface efficiently (Time distribution method (Broadcast/Unicast), reference signal bandwidth/periodicity, or propagation delay compensation methods.) Second, being power efficient (both in the network and the UE).

One part of assessing TDA could also include evaluating alternative possible redundant paths to increase system availability, i.e., not only a primary TDA option but also a secondary option, a third option, etc.

By having assessed different TDA over time when a primary local time reference is available, then when the client network loses its time reference, the TMF would know the most appropriate TDA to be used within the serving network at that specific time based on available current input information that influence the time distribution. It also has the possibility to dynamically change TDA based on detected changes that would influence the time distribution and thereby selection of TDA (e.g., change in radio conditions, UE position, etc.). Also, there is an evaluation of a clock offset in addition to the stability.

Stability or offset measurement reporting and could be performed: (a) before time service becomes operational, (b) at predefined periodic occasions, (c) triggered based on, e.g., a report based on a detected change in stability or offset, (d) requested by the TMF (e.g., based on if new radio conditions detected, if new TDAs or if old TDAs not possible any longer).

The request may comprise a measurement period (e.g., start and stop time) and a reporting formation. The reporting may comprise (i) measurement serving network stability towards a local reference (statistical), (ii) time offset information, (iii) characteristics of the local reference like stability, (iv) measurement time start and stop, and/or (v) measurement confidence.

The TMF may monitor relevant input parameters that could change over time like back up performance requirements, conditions (UE position, RF channel characteristics), etc. and, at each time, the TMF may determine and select currently most appropriate TDA among a set of alternative TDA.

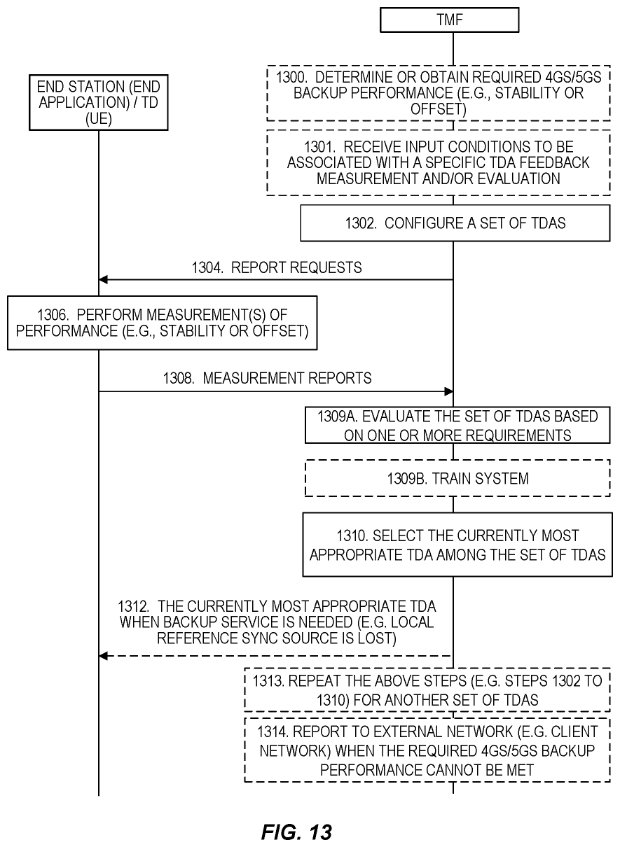

FIG. 13 illustrates an example sequence of actions for the status feedback arrangement.

In step 1300, optionally, a TMF determines or obtains required 4GS/5GS backup performance (e.g., stability or offset of the 4GS/5GS timing).

In step 1301, optionally, the TMF receives input conditions (e.g., RF conditions, UE positions) to be associated with a specific TDA feedback measurement and/or evaluation.

In step 1302, the TMF configures a set of TDAs (e.g., one or more TDAs). To evaluate and compare different TDAs in the set of TDAs, the TMF may need to configure and test those different TDAs, as explained below.

In step 1304, the TMF transmits a set of report requests (e.g., one or more report requests) to an end station (e.g., an end application) or to a TD (e.g., a UE) with respect to the TDAs in the set of TDAs. For example, the report request may comprise a measurement period (e.g., start and stop time) and/or a reporting format.

In step 1306, the end station (e.g., the end application) or the TD (e.g., a UE) performs measurements of the performance (e.g., stability or offset) with respect to the TDAs in the set of TDAS.

In step 1308, the TMF receives, from the end station (e.g., the end application) or the TD (e.g., the UE), a set of measurement reports regarding the measurements. For example, the measurement report may comprise (i) measurement serving network stability towards a local reference (statistical), (ii) time offset information, (iii) characteristics of the local reference like stability, (iv) measurement time start and stop, and/or (v) measurement confidence. Each measurement in the set of measurement reports is specific to a specific TDA with the conditions described earlier. The backup performance of a TDA with the conditions can be stored and a system is trained over time (when not used as a backup). Once the serving network actually shall act as a backup, then at that specific time based on stored data, under training and existing present conditions, the TMF knows the most appropriate TDA to use among all evaluated TDAS, in addition to the actual, required backup performance at the backup occasion (inputs in FIG. 8).

In step 1309A, the TMF evaluates the set of TDAs based on one or more requirements, such as (a) the set of measurement reports, (b) required back up performance, (c) the end station's position, and/or (d) RF channel characteristics.

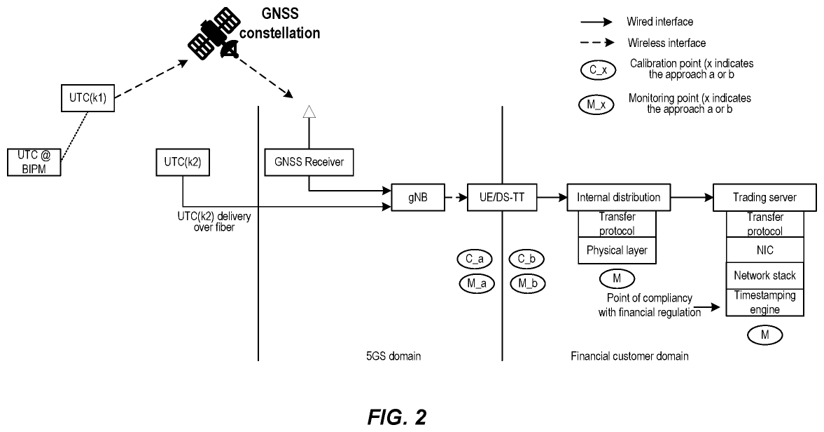

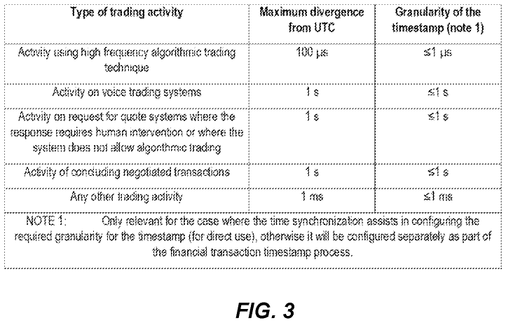

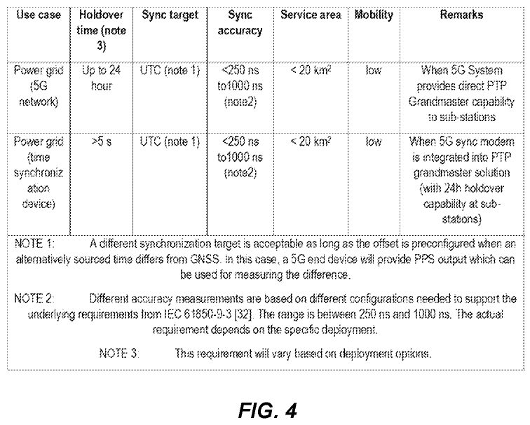

In step 1309B, optionally, the TMF may train a system and collect sufficiently different TDAs with related measurement reports. The system may be a trained system i.e., over time and various conditions different TDAs with their own properties are tested this to evaluate the most appropriate TDA at the (rare) events when needed as a backup. For example, the system (or the trained system) may correspond to one of the elements in FIG. 2, 5, 6, and 9-12, or 14. For example, hardware configurations or implementations of the system (or the trained system) may be well-known in the relevant art.

In step 1310, the TMF selects a currently most appropriate TDA among the set of TDAs, based on one or more conditions as shown in FIG. 8, which are (a) required 4GS/5GS backup performance (e.g., stability or timing offset), (b) conditions (e.g., RF channel characteristics, UE position), (c) RF resource availability, and/or (d) energy efficiency constraints. The most appropriate TDA is dependent and associated to the actual time when needed as a backup node. This can be evaluated regularly and at the time when needed it knows the TDA to be used or it could be evaluated at the backup request. During back-up duration a TDA can be changed based on changed inputs. The serving network is configured to use the most appropriate TDA at the time (and duration) of the back-up service requested.

In one embodiment, the evaluation is expected to be done on some regular basis when not used as a backup when a local reference is lacking. Then, the selection can be done regular as well, i.e. at present time, since it always knows, based on required performance, conditions and trained system, the most appropriate TDA to be used. The most appropriate TDA is selected when requested to be used as a backup. Hence the selection could be done as a part of the request as well. The system is trained to use the most appropriate TDA when the system is used as a backup.

In step 1312, optionally, the TMF transmits the currently most appropriate TDA when a backup service is needed (e.g., a local reference sync source is lost).

In step 1313, optionally, the TMF repeats some or all of the above steps (e.g., steps 1302 to 1310) for another set of TDAS.

In step 1314, optionally, when the required 4GS/5GS backup performances (e.g., stability or offset of the 4GS/5GS timing) are not or cannot be met by any TDA in the set of TDAs after the evaluation (in step 1309A), the TMF may report to an external network (client network), for example, the client network to which the 4GS/5GS will provide the timing service, via AF or UE application. The report to the external network may contain: (i) Boolean parameter indicating whether or not the service is within the required levels of: accuracy, (new) stability, UTC traceability (which are provided by AF when the time synchronization service is requested, using procedures in TS 23.502, clause 4.15.9), where adding stability in the AF request is a new proposed requirement, (ii) (optionally) when the levels are out of range, the report may contain the current value of the parameter (error budget, stability, UTC traceability, or any other added during Rel-18 work) that is out of range.

The AF may additionally include, in its request for time synchronization service, a required level of stability. Other parameters in the request included in the required error budget (based on current 3GPP specification) and required UTC traceability (based on current Rel-18 approved solution). Regardless of using or not a method to select TDA, the 5GS may provide status report to UE application or end station connected to it (which can be provided directly if available at those devices or UE) and may provide status report to AF on whether the levels of the requirements are achieved or not, by performing the corresponding measurements. When not achieved the 5GS may optionally provide the current value of the parameter(s) that was underperforming (not according to requirements).

### Verification that the Timestamp (e.g., of Financial Transactions) is Correct

For some time-stamping applications, there may be legal or other requirements to verify that a transaction time stamp of the application can be trusted. The transaction may use a time service delivered over a fixed internet connection (PTP or NTP) or by GNSS. The time stamp is then verified by sending a reference of the transaction across a time stamping UE and via a mobile network (e.g., 4G system, EPS or 5G System, 5GS). It is assumed the compliance is monitored by a verification authority outside the mobile network.

There is a time transfer interface between the serving network and the client network. The time transfer interface may be the same interface as described in Assisted time service support. The time stamping application may run in the client network. The serving network (4G or 5G) is aware when the client network has the correct time or not. When the serving network has the correct time, the serving network can evaluate the time of the client network time's stamping application.

Since the serving network is synchronized and is aware of its synchronization status, it is sufficient that the serving network (e.g., 4G/5G) compares the time of its own clock to the time of the client network application. In case where the serving network detects a stability discrepancy, an indication of such an event can be sent to the verification authority. The serving network also sends information to the verification authority in case that the serving network has lost time synchronization. These states can be indicated, e.g., by a trust flag.

As an extension to further increase the trust of the client network's timestamp, the actual timestamp can be transferred across the client server's network interface, and together with a trust flag added by the serving network is passed on to the verification authority. The serving network evaluates the client network time stamp against its own time information. In this case, the suggested trust flag can be set to ‘true’ if the client network's time stamp corresponds to the serving network's own time within the required boundaries. The client network may send its time stamp immediately after the time stamp is created, so that the serving network can make a corresponding time stamp with its own clock when the serving network receives the client network's time stamp.

### Simplified Sync as a Service to Calibrate Local Inaccurate Timing References

One potential service that can be offered is a UTC traceable Phase reference that can be used to realign in phase a local “inaccurate” time reference (e.g., NTP based or PTP over partial timing support). Typical NTP implementations (e.g., over public IP networks), can guarantee an accuracy with respect to the UTC time, in the order of a few milliseconds (or in the best case, hundreds of microseconds).

In principle, PTP over partial timing support of the same network would also be able to achieve similar performance (hundreds of microseconds). Typically, PTP would be deployed over “controlled” networks, therefore, PTP would be able to achieve better performance, but still in the order of tens of microseconds in the best case, unless some pre-calibration is performed (e.g., to remove asymmetry), or the network load is controlled below a certain threshold in order to reduce a packet delay variation. Many applications, however, require much better accuracy, for example, better than 10 or 5 microseconds, or better than 1 microsecond in some cases.

By combining the local UTC traceable, but “inaccurate” timing reference, with the phase delivered by the 3GPP signal, it is possible to generate a timing reference that is both UTC traceable and accurate within 1-5 microseconds.

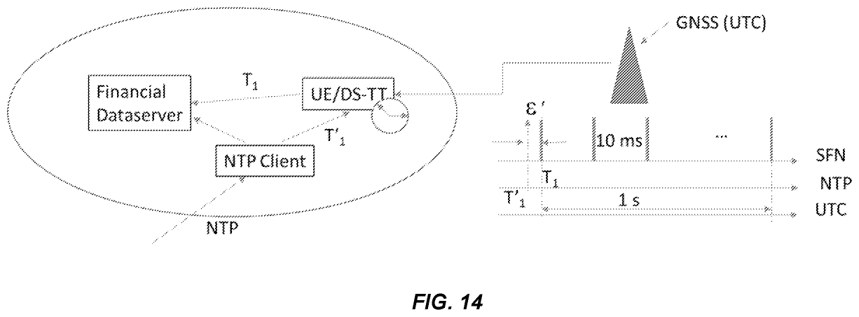

In FIG. 14, the above-described concept is shown with an example applied to financial service application.

Originally, the requirements for financial applications have not been too stringent. Timestamping in the order of several milliseconds (ms) was sufficient. Therefore, NTP has often been used to address the financial applications. More recently, PTP over partial timing support has been used to address the financial application as disclosed in IETF, “Enterprise Profile for the Precision Time Protocol with Mixed Multicast and Unicast Messages.”

However, the requirement became much more stringent in the recent years, for example, due to new regulatory requirements for UTC traceability and accuracy better than 100 microseconds.

In the solution proposed in the present disclosure to address this problem, as an example, the time distributed to a Financial server is using NTP. In this example, it is assumed that the accuracy that can be guaranteed by the NTP service is e′<+/−5 milliseconds (i.e., deviation from the ideal UTC time is less than 5 milliseconds).

The recovered NTP time reference is distributed to the local Timing Device (e.g., that could be implemented within a “DS-TT” as defined in 3GPP TS 23.501 V17.3.0 (2021 December)) that also is connected to a UE through which it can receive 3GPP radio interface derived timing.

The frame timing of the 3GPP radio interface is controlled and aligned towards UTC by a gNB having access to a UTC traceable reference (e.g., GNSS) and its accuracy within the UE (e.g., DS-TT) can be assumed to be in the order of a few microseconds (better than 10 microseconds) including RF air interface delay errors and internal UE errors.

The start of the radio frame is used by the TD (e.g., DS-TT) to re-align and to improve original NTP UTC timing to be better than 10 microseconds accuracy (e<10 microseconds). In practice moving, the NTP reference to the closest start of the radio frame. The actual accuracy required (or that can be offered) is agreed at the service establishment phase.

Moreover, other characteristics should be agreed during this phase, such as reliability (e.g., 99% of the time, the reference is available within the agreed performance, and consecutive loss of the reference for no more than 1 hour, etc.).

Due to the facts that the NTP time is accurate within +/−5 ms and that the radio frame has a periodicity of 10 ms, the NTP “second” may correspond to the closest edge of the start of a radio frame.

The main benefits are described below.

First, no need to send any specific timing data over the 5G radio. It is only required a “certified” UTC traceability of the radio signal (not even SIB needs to be sent for this service). This assumes I radio frames are aligned without any fixed offset to UTC time, i.e., there exists periodic radio frames (100 frames each 10 milliseconds) with frame starts aligned to UTC seconds. It only needs to be enabled at the service activation. The exposure Application Programming Interface (API) would support additional parameters that the AF learns in order to properly build the request to activate the time synchronization service, according to clause 4.15.9.3 in TS 23.502 V17.3.0 (2021 December). The current service parameters to be provided by AF are listed in Table 4.15.9.3-1, of TS 23.502 V17.3.0 (2021 December) (which includes accuracy). In order to activate this service, it is required to add the following new parameters: UTC traceability and reliability.

Second, by generating a local time at the UE/DS-TT, the 5G system could also monitor the NTP (as per previous use case in the above section of “Verification that the timestamp (e.g., of financial transactions) is correct”).

If the NTP time is beyond +/−5 millisecond (ms) accuracy (i.e., NTP cannot uniquely identify the radio frame corresponding to an integer of UTC second) or if the radio frames have an offset to UTC as mentioned earlier, then for improving the accuracy, the relation between radio frames (SFN) and UTC needs to be provided (e.g., like as possible with SIB 9). The benefit in this case, if compared with the already-defined services (e.g., timing carried over 3GPP radio for one of the following two options: (a) as a back up to a local GNSS (b) as a primary source where GNSS is not available), is that the 5GS does not need to send additional data over the radio interface that would be required to provide/support the timing protocol required by the application (e.g., to support PTP or NTP timing generation).

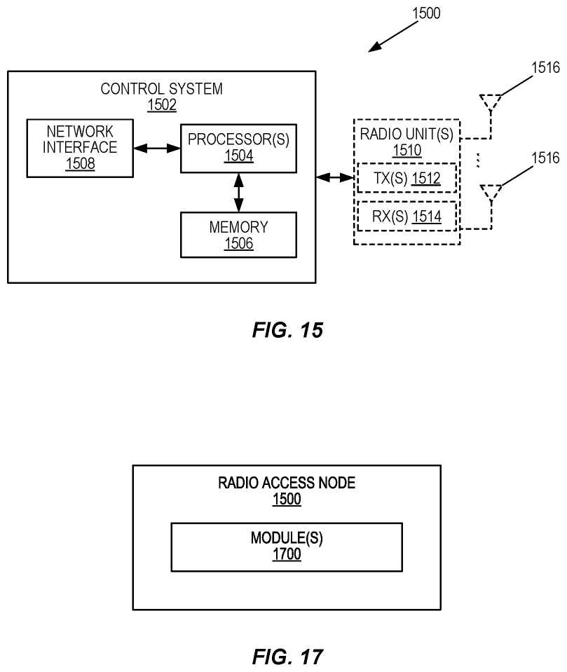

FIG. 15 is a schematic block diagram of a radio access node 1500 according to some embodiments of the present disclosure. Optional features are represented by dashed boxes. The radio access node 1500 may be, for example, a base station 902 or 906 or a network node that implements all or part of the functionality of the base station 902 or gNB described herein. As illustrated, the radio access node 1500 includes a control system 1502 that includes one or more processors 1504 (e.g., Central Processing Units (CPUs), Application Specific Integrated Circuits (ASICs), Field Programmable Gate Arrays (FPGAs), and/or the like), memory 1506, and a network interface 1508. The one or more processors 1504 are also referred to herein as processing circuitry. In addition, the radio access node 1500 may include one or more radio units 1510 that each includes one or more transmitters 1512 and one or more receivers 1514 coupled to one or more antennas 1516. The radio units 1510 may be referred to or be part of radio interface circuitry. In some embodiments, the radio unit(s) 1510 is external to the control system 1502 and connected to the control system 1502 via, e.g., a wired connection (e.g., an optical cable). However, in some other embodiments, the radio unit(s) 1510 and potentially the antenna(s) 1516 are integrated together with the control system 1502. The one or more processors 1504 operate to provide one or more functions of a radio access node 1500 as described herein. In some embodiments, the function(s) are implemented in software that is stored, e.g., in the memory 1506 and executed by the one or more processors 1504.

FIG. 16 is a schematic block diagram that illustrates a virtualized embodiment of the radio access node 1500 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1500 in which at least a portion of the functionality of the radio access node 1500 is implemented as a virtual component(s) (e.g., via a virtual machine(s) executing on a physical processing node(s) in a network(s)). As illustrated, in this example, the radio access node 1500 may include the control system 1502 and/or the one or more radio units 1510, as described above. The control system 1502 may be connected to the radio unit(s) 1510 via, for example, an optical cable or the like. The radio access node 1500 includes one or more processing nodes 1600 coupled to or included as part of a network(s) 1602. If present, the control system 1502 or the radio unit(s) are connected to the processing node(s) 1600 via the network 1602. Each processing node 1600 includes one or more processors 1604 (e.g., CPUs, ASICs, FPGAS, and/or the like), memory 1606, and a network interface 1608.

In this example, functions 1610 of the radio access node 1500 described herein are implemented at the one or more processing nodes 1600 or distributed across the one or more processing nodes 1600 and the control system 1502 and/or the radio unit(s) 1510 in any desired manner. In some particular embodiments, some or all of the functions 1610 of the radio access node 1500 described herein are implemented as virtual components executed by one or more virtual machines implemented in a virtual environment(s) hosted by the processing node(s) 1600. As will be appreciated by one of ordinary skill in the art, additional signaling or communication between the processing node(s) 1600 and the control system 1502 is used in order to carry out at least some of the desired functions 1610. Notably, in some embodiments, the control system 1502 may not be included, in which case the radio unit(s) 1510 communicate directly with the processing node(s) 1600 via an appropriate network interface(s).

In some embodiments, a computer program including instructions which, when executed by at least one processor, causes the at least one processor to carry out the functionality of radio access node 1500 or a node (e.g., a processing node 1600) implementing one or more of the functions 1610 of the radio access node 1500 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

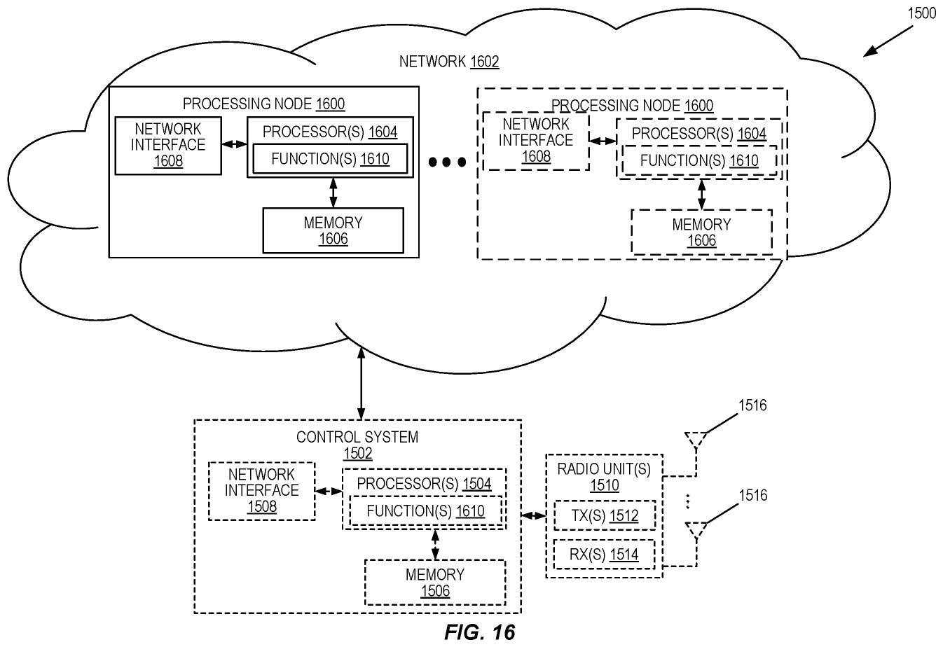

FIG. 17 is a schematic block diagram of the radio access node 1500 according to some other embodiments of the present disclosure. The radio access node 1500 includes one or more modules 1700, each of which is implemented in software. The module(s) 1700 provide the functionality of the radio access node 1500 described herein. This discussion is equally applicable to the processing node 1600 of FIG. 16 where the modules 1700 may be implemented at one of the processing nodes 1600 or distributed across multiple processing nodes 1600 and/or distributed across the processing node(s) 1600 and the control system 1502.

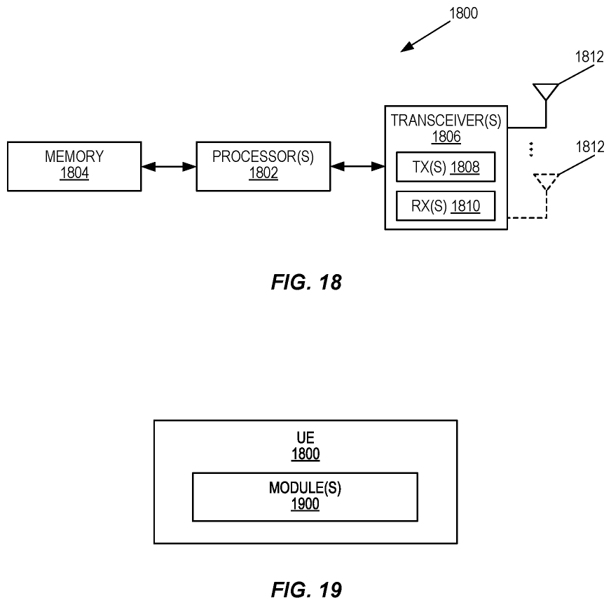

FIG. 18 is a schematic block diagram of a wireless communication device 1800 according to some embodiments of the present disclosure. As illustrated, the wireless communication device 1800 includes one or more processors 1802 (e.g., CPUs, ASICS, FPGAS, and/or the like), memory 1804, and one or more transceivers 1806 each including one or more transmitters 1808 and one or more receivers 1810 coupled to one or more antennas 1812. The transceiver(s) 1806 includes radio-front end circuitry connected to the antenna(s) 1812 that is configured to condition signals communicated between the antenna(s) 1812 and the processor(s) 1802, as will be appreciated by on of ordinary skill in the art. The processors 1802 are also referred to herein as processing circuitry. The transceivers 1806 are also referred to herein as radio circuitry. In some embodiments, the functionality of the wireless communication device 1800 described above may be fully or partially implemented in software that is, e.g., stored in the memory 1804 and executed by the processor(s) 1802. Note that the wireless communication device 1800 may include additional components not illustrated in FIG. 18 such as, e.g., one or more user interface components (e.g., an input/output interface including a display, buttons, a touch screen, a microphone, a speaker(s), and/or the like and/or any other components for allowing input of information into the wireless communication device 1800 and/or allowing output of information from the wireless communication device 1800), a power supply (e.g., a battery and associated power circuitry), etc.

In some embodiments, a computer program including instructions which, when executed by at least one processor, causes the at least one processor to carry out the functionality of the wireless communication device 1800 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 19 is a schematic block diagram of the wireless communication device 1800 according to some other embodiments of the present disclosure. The wireless communication device 1800 includes one or more modules 1900, each of which is implemented in software. The module(s) 1900 provide the functionality of the wireless communication device 1800 described herein.

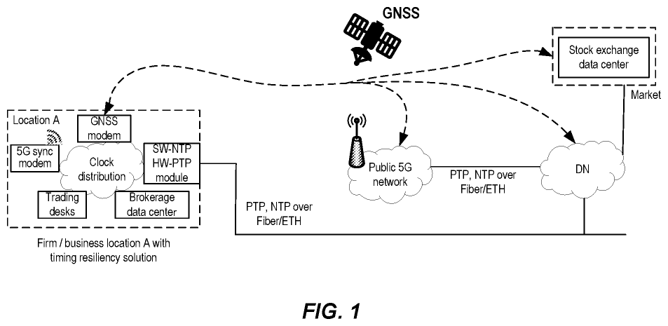

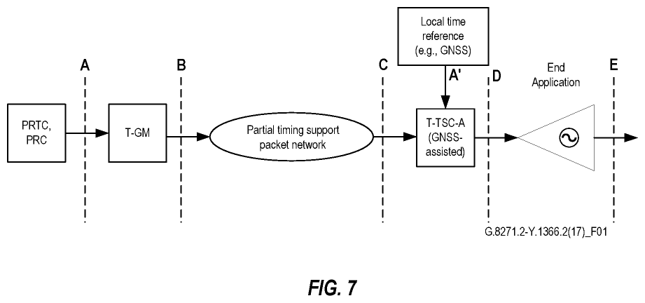

The following section is copied from the Appendix included with the filing of the priority document, U.S. Provisional Application No. 63/320,841, filed Mar. 17, 2022. The foregoing set up is shown in FIG. 7 of the instant application (taken from FIG. 1 in the 63/320,841 application Appendix: “Copy of FIG. 1/G.8271.2 [4] ‘Reference model for network limits for assisted partial timing support’”).

### Beginning of Appendix Material

### Background: What is Assisted Partial Timing Support (APTS)

Assisted partial timing support is specified in G.8271.2 by ITU-T.

Distribution of a reference timing signal can be done via the IEEE1588 Precision Time Protocol (PTP). Highest accuracy can be achieved when all network elements along the path (switches and/or routers) are able to terminate and regenerate the PTP messages (i.e., via boundary clock or transparent clock functionality). When the transport network elements do not support the processing of PTP, the timing reference is distributed in so called “partial timing support” delivering PTP over IP over the network. This leads to some degradation of the timing reference due to packet delay variation added by the network.

One special set up, “assisted partial timing support, has been defined by ITU-T where this “noisy” reference is only used as back-up to a local accurate reference (typically based on a GNSS receiver). In normal operation the accurate local reference is used to “calibrate” the noisy PTP reference. When the local reference is lost, assuming the network where PTP is carried is within certain Packet delay variation limits, the PTP reference can be used as a secondary reference over limited time period (e.g., 1 day), This set up is shown in the FIG. 1 (taken from G.8271.2). Caption: FIG. 1. Copy of FIG. 1/G.8271.2 [4] “Reference model for network limits for assisted partial timing support.” [Editorial Note: FIG. 1 referred to here is FIG. 7 in U.S. 63/320,841, and in the instant application.]

### Use of APTS in the Context of Time Synchronization and Timing Resiliency for Backup

The main idea is to propose a solution for a new simplified timing service in 5G which is analogous to the assisted partial timing support. The benefit by adding APTS whenever the client network (via AF) indicated it is a requirement, is the reduced impact on 5G system, e.g., no additional requirements on the existing synchronization solutions with minimal addition of few parameters in the AF request which are then delivered to 5G-AN. Another benefit is allowing to multiply the range of service opportunities in the area addressing new types of applications.

The solution is divided between the serving network (the 5G Network) and the client Network (the network that has a need of reliable time).

The basic principle for the assisted time service is that the client network has a local time solution providing time information for a critical service such as monitoring a power grid or time stamping critical events. Such local time solutions might suffer from availability issues, e.g., using time locally from GNSS systems.

To increase the availability of time information, the serving network can provide a backup solution.

The solution builds on the fact that the local time is correct and has sufficient accuracy for the client network as long as its primary time reference is functional.

In case the local time reference fails, the local clock can continue to tick with high accuracy if it is provided with a highly stable frequency or phase information from the serving network.

This is inspired by the basic principle outlined in ITU-T G.8275.2 APTS option. The principle is that:
For the APTS solution the serving network is a PTP over IP over cable solution, and here the serving network is the 5G Network including the UE.
The APTS solution is limited to support GNSS with the PTP over IP connection, and only phase information from the PTP over IP connection is used. Here the support is provided over radio and via a more accurate and stable reference (if compared with PTP/IP in partial timing support). Also, in this case it can be used to support any type of local timing reference.
For the APTS solution, there is a tight integration between the application running both the GNSS time synchronization and the PTP over IP connection, and there is no service interface between the GNSS time and the PTP time networks. Here, a clear client/serving separation is made since the 5G Network must be able to offer backup as a service (via exposure interface). There are optional ways for the 5G Network to provide a stable phase or frequency interface.

1. It can provide a stable time/phase by utilizing the time synchronization capability of the gNodeB (or eNodeB), distribution time to the UE, which can provide an assisting time interface to the client network. The absolute time accuracy of the serving network can be less than the required time accuracy by the client network. The requirement on the serving network is that the stability of the phase of the serving network is better than the required time accuracy of the client network.

2. It can provide a stable frequency by utilizing a highly accurate frequency/phase delivered by gNodeB (Or eNodeB) to the UE, which can provide a stable frequency/phase interface to the client network. The serving network frequency does not contain time phase information. It contains only frequency information, and the phase that an oscillating signal inherently has. The requirement on the serving network is that the stability of the phase of the serving network is better than the required time accuracy of the client network.

Proposal 1: The AF request from the client network indicates whether APTS is to be used and which option (frequency & phase or only frequency), and the required stability.

Proposal 2: The serving network (5GS) will inform the client network whether the stability has degraded outside the acknowledged stability commitment, as part of the status report.

It is assumed the client network monitors its primary time reference and when it no longer trusts the primary time reference takes a decision to use the serving network backup signal to advance its clock.

For case 1, it is assumed it has calculated the time difference between its primary time reference and the backup time provided by the serving network in an earlier phase when it trusted its primary time reference, and when using the serving network time compensates for the difference.

An alternative for calculating the time difference is that the Client network provides its time information to the serving network as long as it trusts its primary time reference, and that the serving network calculates the difference and compensates the time information the serving network delivers. This compensation can be done locally close to the service interface, since with this method, the time that is delivered will be locally adapted to the client network.

For case 2 there is no need to exchange time information across the Client server interface.

The serving network must assess its stability. This can be done by the serving network itself by using built in high stability oscillators in the gNodeB/eNodeB that has an intrinsic stability better that the required client network stability, or by utilizing a time interface from the client network to the serving network to monitor the stability of its own frequency/phase.

### Assisted Timing in the Context of Time Synchronization and Timing Resiliency for Complement Timing Support

The main idea is to use an assisted timing in order to offer a simplified synchronization as a complement to calibrate local inaccurate timing references at the client network.

One potential service that can be offered is a UTC traceable Phase reference that can be used to realign in phase a local “inaccurate” time reference (e.g., NTP based or PTP over partial timing support).

Typical NTP implementations (e.g., over public IP networks), can guarantee an accuracy with respect to the UTC time, in the order of a few milliseconds (or in the best case, hundreds of microseconds).

In principle, PTP over partial timing support of the same network would also be able to achieve similar performance (hundreds of us). Typically, PTP would be deployed over “controlled” networks, therefore able to achieve better performance, but still in the order of tens of us in the best case, unless some pre-calibration is performed (e.g., to remove asymmetry), and/or the network load is controlled below a certain threshold in order to reduce packet delay variation.

Many applications however require much better accuracy, better than 10 or 5 us. Or better than 1 us in some cases.

By combining the local UTC traceable, but “inaccurate” timing reference, with the phase delivered by the 3GPP signal, it is possible to generate a timing reference that is both UTC traceable and accurate within 1-5 us.

Proposal 3: AF may request type of timing information to be only phase.

Originally, the requirements for financial applications have not been too stringent. Timestamping in the order of several ms, was sufficient. Therefore, NTP has often been used to address this application (more recently PTP over partial timing support as per: IETF, Enterprise Profile for the Precision Time Protocol With Mixed Multicast and Unicast Messages (https://datatracker.ietf.org/doc/html/draft-ietf-tictoc-ptp-enterprise-profile).

The requirement became much more stringent in the recent years, e.g., due to new regulatory requirements for UTC traceability and accuracy better than 100 us (see MiFID2).

For example, if the time distributed to a financial server is using NTP, the recovered NTP time reference is distributed to the local Timing Device (e.g., that could be implemented within a “DS-TT” as defined in 3GPP TS 23.501) that also is connected to a UE through which it can receive 3GPP radio interface derived timing.

The frame timing of the 3GPP radio interface is controlled and aligned towards UTC by a gNB having access to a UTC traceable reference (e.g., GNSS) and its accuracy within the UE (e.g. DS-TT) can be assumed to be in the order of a few us (better than 10 us) including RF air interface delay errors and internal UE errors.

The start of the radio frame is used by the Timing Device to re-align and to improve original NTP UTC timing by having a better accuracy. In practice moving the NTP reference to the closest start of the radio frame.

The actual accuracy required (or that can be offered) was already provided via AS time distribution method.

Moreover, other characteristics should be agreed during this phase, such as reliability (e.g., 99% of the time, the reference is available within the agreed performance, and consecutive loss of the reference for no more than 1 hour, etc.).

Proposal 4: add reliability characteristics to the AF request.

Due to the fact that the NTP time is accurate within +/−5 ms, and that the radio frame has a periodicity of 10 ms, the NTP “second” must correspond to the closest edge of the start of a radio frame.

Proposal 5: Since the methods defined in 1.2 and 1.3 are strictly used for timing resiliency, even if they are activated by time synchronization service activation framework from Rel-17, still there is a need to specify whether the service is used for timing resiliency, in which case, RAN can be informed too.

It is proposed to agree the following changes to 23.700-25:

### Beginning of Changes

### 6.X Solution #X: Assisted Timing Support

### 6.X.1 Introduction

This solution is strictly addressing the requirement for timing resiliency towards and client network (external network that requires a resilient timing service by the 5GS), as backup when the local primary time source fails, or as a complement to calibrate inaccurate timing sources in the client network.

This solution proposes to the support for Assisted Partial Timing (as defined in ITU-T G.8275.2) to provide backup timing service which if applied to 5GS implies a very low impact and the only timing information to be provided is phase and/or frequency. Also a more generic assisted timing may be provided in order to complement (by calibrating) the external inaccurate primary local source.

Originally, the requirements for financial applications have not been too stringent. Timestamping in the order of several ms, was sufficient. Therefore, NTP has often been used to address this application (more recently PTP over partial timing support as per: IETF, Enterprise Profile for the Precision Time Protocol With Mixed Multicast and Unicast Messages (https://datatracker.ietf.org/doc/html/draft-ietf-tictoc-ptp-enterprise-profile).

This solution of 5G assisted timing as backup is inspired by the basic principle outlined in ITU-T G.8275.2 APTS option. The principle is that:
For the APTS solution the serving network is a PTP over IP over cable solution, and here the serving network is the 5G Network including the UE.
The APTS solution is limited to support GNSS with the PTP over IP connection, and only phase information from the PTP over IP connection is used. Here the support is provided over radio and via a more accurate and stable reference (if compared with PTP/IP in partial timing support). Also, in this case it can be used to support any type of local timing reference.
For the APTS solution, there is a tight integration between the application running both the GNSS time synchronization and the PTP over IP connection, and there is no service interface between the GNSS time and the PTP time networks. Here, a clear client/serving separation is made since the 5G Network must be able to offer timing resiliency as a service (via exposure interface).

If the client network supports receiving some form of assisted timing and requests for a Timing Resiliency service from 5GS via de usual Time Synchronization service activation, the 5GS will be able to provide assisted timing, where the timing information may be phase and/or frequency. The stability of those parameters needs to be guaranteed, therefore also a requirement on the stability is necessary. The AF request therefore may indicate in the Time Synchronization service activation, using the Access Stratum Time Distribution method, that Timing Resiliency additional service is required, whether assisted timing is required, the type to timing information (phase-only, phase and frequency, or frequency-only), reliability, and the required stability.

If assisted timing is required to provide timing resiliency, the client network should be receiving a feedback (status report) on whenever the stability of the timing information (phase and/or frequency) and reliability characteristic was not achieved. Moreover, status reports are provided when any of the required parameters (including also error budget, UTC traceability) are not achieved. How to provide the status report is out of the scope if this solution.

### 6.X.2 Functional Description

This solution is based on the following principles:
AF may include in its request for time synchronization service using the Access Stratum Time distribution method if the following are required:
Timing Resiliency additional service:
assisted timing requirement,
type to timing information required,
reliability, and
stability level.
Status report to UE application and to AF may contain: whenever the stability of the timing information specific for assisted timing (phase and/or frequency), reliability characteristic, or any other requirement was not achieved

### 6.X.3 Procedures

Existing time synchronization activation procedures (see TS 23.502, clause 4.15.9) related to Access Stratum Time Distribution method are reused, where the AF request content is modified to include: Timing Resiliency additional service requirement, whether timing assistance is required, the type to timing information (phase-only, phase and frequency, or frequency-only), and the required stability.

### 6.X.4 Impacts on Services, Entities and Interfaces

AF: Formulation of the AF request that may include parameters indicating requirement for Timing Resiliency, and assisted timing. These parameters are delivered together with error budget per Uu interface to RAN.
RAN: gNB will receive the parameters and deliver the timing information based on requested service, which should be lower impact when it comes to delivering phase and/or frequency to UE instead of time. This is out of scope in SA2. In any case, Timing Resiliency additional service has to be notified to RAN.

### End of Changes

### End of Appendix Material

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

Embodiment 1: A method performed by a Time Management Function, TMF, for selecting a Time Distribution Alternative, TDA, the method comprising: configuring (1302) a set of TDAs; transmitting (1304), to an end station or a Timing Device, TD, a set of report requests with respect to the set of TDAs; receiving (1308), from the end station or from the TD, a set of measurement reports with respect to the set of TDAS, each of the set of measurement reports being specific TDA with input conditions; evaluating (1309A) the set of TDAs based one or more requirements and the set of measurement reports; and selecting (1310) a currently most appropriate TDA among the set of TDAs based on results of the evaluating step and one or more conditions that may relate to the input conditions.

Embodiment 2: The method of embodiment 1, further comprising: receiving (1301) the input conditions to be associated with a specific TDA feedback measurement and/or evaluation; and repeating (1314) the above steps (1304 to 1310).

Embodiment 3: The method of embodiment 1 or 2, further comprising training (1309B) a system and collecting sufficiently different TDAs with related measurement reports.

Embodiment 4: The method of any of embodiments 1 to 3, further comprising determining or obtaining (1300) one or more of required Fourth Generation System, 4GS, and/or Fifth Generation System, 5GS, backup performances.

Embodiment 5: The method of embodiment 4, wherein the one or more of required 4GS and/or 5GS backup performances comprise a stability of a timing in the 4GS and/or the 5GS or an offset of the timing in the 4GS and/or the 5GS.

Embodiment 6: The method of any of embodiments 1 to 5, wherein the report request comprises a measurement period (e.g., start and stop time) and/or a reporting format.

Embodiment 7: The method of any of embodiments 1 to 6, wherein the measurement report comprises one or more of (i) a measurement serving network stability towards a local reference (statistical), (ii) timing offset information, (iii) characteristics of the local reference like stability, (iv) a measurement start time and a measurement stop time, and/or (v) measurement confidence.

Embodiment 8: The method of any of embodiments 1 to 7, wherein the one or more input conditions to evaluate the set of TDAs comprise a back-up performance, a position of the end station, or Radio Frequency, RF, channel characteristics.

Embodiment 9: The method of any of embodiments 1 to 8, wherein the one or more conditions to select the currently most appropriate TDA among the set of TDAs are (a) required 4GS/5GS backup performance (e.g., stability or timing offset), (b) conditions, (c) RF resource availability, and/or (d) energy efficiency constraints.

Embodiment 10: The method of any of embodiments 1 to 9, further comprising reporting (1314) to an external network when the required 4GS/5GS backup performances are not or cannot be met by any TDA in the set of TDAs after the set of TDAs are evaluated (1309A).

Embodiment 11: The method of embodiment 10, wherein the external network is a client network to which the 4GS/5GS will provide the timing service via an Application Function, AF.

Embodiment 12: The method of embodiment 11, wherein the AF sends a request for time synchronization service, including one or more of (a) a required level of stability, (b) a required error budget, and/or (c) required UTC traceability.

Embodiment 13: The method of any of embodiments 1 to 12, wherein the end station is an end application and the TD is a User Equipment, UE.

Embodiment 14: A method performed by an end station or by a Timing Device, TD, for performing a measurement related to a timing of a Fourth Generation System, 4GS, and/or a Fifth Generation System, 5GS, the method comprising: receiving (1304), from a Time Management Function, TMF, a set of report requests with respect to the set of Time Distribution Alternatives, TDAs; performing (1306) measurements of a set of performances related to the set of report requests with respect to the set of TDAS;
transmitting (1308), to the TMF, a set of measurement reports on the measurements of the set of performances with respect to the set of TDAs; and receiving (1312) a currently most appropriate TDA among the set of TDAs when a backup service is needed.

Embodiment 15: The method of embodiment 14, wherein the measurements of the set of performances comprise one or more of (i) a stability of the timing in the 5GS or (ii) an offset of the timing in the 5GS.

Embodiment 16: The method of embodiment 14 or 15, wherein the end station is an end application and the TD is a User Equipment, UE.

Those skilled in the art will recognize improvements and modifications to the embodiments of the present disclosure. All such improvements and modifications are considered within the scope of the concepts disclosed herein.

1. A method performed by a Time Management Function, TMF, for selecting a Time Distribution Alternative, TDA, the method comprising:
configuring a set of TDAs;
transmitting, to an end station or a Timing Device, TD, a set of report requests with respect to the set of TDAs;
receiving, from the end station or from the TD, a set of measurement reports with respect to the set of TDAs, each of the set of measurement reports being specific to a TDA from the set of TDAs and includes corresponding input conditions;
evaluating the set of TDAs based one or more requirements and the set of measurement reports; and
selecting a currently most appropriate TDA among the set of TDAs based on results of the evaluating step and one or more conditions that may relate to the input conditions.

2. The method of claim 1, further comprising:
receiving the input conditions to be associated with a specific TDA feedback measurement and/or evaluation; and
repeating the transmitting the set of report requests, the receiving the set of measurement reports, the evaluating the set of TDAs, and the selecting the currently most appropriate TDA.

3. The method of claim 1, further comprising:
training a system and collecting different TDAs with related measurement reports and associated input conditions.

4. The method of claim 1, further comprising determining or obtaining one or more of required Fourth Generation System, 4GS, and/or Fifth Generation System, 5GS, backup performances.

5. The method of claim 4, wherein the one or more of required 4GS and/or 5GS backup performances comprise a stability of a timing in the 4GS and/or the 5GS or an offset of the timing in the 4GS and/or the 5GS.

6. The method of claim 1, wherein the report request comprises a measurement period (e.g., start and stop time) and/or a reporting format.

7. The method of claim 1, wherein the measurement report comprises one or more of (i) a measurement of serving network stability towards a local reference (statistical), (ii) timing offset information, (iii) characteristics of the local reference including one or more of stability and accuracy, (iv) a measurement start time and a measurement stop time, and/or (v) measurement confidence.

8. The method of claim 1, wherein the one or more input conditions to evaluate the set of TDAs comprise a back-up performance, a position of the end station, or Radio Frequency, RF, channel characteristics.

9. The method of claim 1, wherein the one or more conditions to select the currently most appropriate TDA among the set of TDAs are (a) required 4GS/5GS backup performance (e.g., stability or timing offset), (b) conditions, (c) RF resource availability, and/or (d) energy efficiency constraints.

10. The method of claim 1, further comprising reporting to an external network when the required 4GS/5GS backup performances are not or cannot be met by any TDA in the set of TDAs after the set of TDAs are evaluated.

11. (canceled)

12. (canceled)

13. The method of claim 1, wherein the end station is an end application and the TD is a User Equipment, UE.

14. The method of claim 1, wherein the configuring the set of TDAs, the transmitting the set of report requests, and the receiving the set of measurement reports is repeated in cycles on a per TDA basis.

15. The method of claim 1, wherein the corresponding input conditions comprise conditions present at the TDA during testing to generate a measurement report from the set of measurement reports corresponding to the TDA.

16. A method performed by an end station or by a Timing Device, TD, for performing a measurement related to a timing of a Fourth Generation System, 4GS, and/or a Fifth Generation System, 5GS, the method comprising:
receiving, from a Time Management Function, TMF, a set of report requests with respect to a set of Time Distribution Alternatives, TDAs;
performing measurements of a set of performances related to the set of report requests with respect to the set of TDAs;
transmitting, to the TMF, a set of measurement reports on the measurements of the set of performances with respect to the set of TDAs; and
receiving a currently most appropriate TDA among the set of TDAs when a backup service is needed.

17. The method of claim 16, wherein the measurements of the set of performances comprise one or more of (i) a stability of the timing in the 5GS or (ii) an offset of the timing in the 5GS.

18. The method of claim 16, wherein the end station is an end application and the TD is a User Equipment, UE.

19. A Time Management Function, TMF, apparatus for selecting a Time Distribution Alternative, TDA, the TMF apparatus comprising:
receiver circuitry; and
processing circuitry associated with the receiver circuitry, the processing circuitry configured to cause the TMF apparatus to at least:
configure a set of TDAs;
transmit, to an end station or a Timing Device, TD, a set of report requests with respect to the set of TDAs;
receive, from the end station or from the TD, a set of measurement reports with respect to the set of TDAs, each of the set of measurement reports being specific TDA with input conditions;
evaluate the set of TDAs based one or more requirements and the set of measurement reports; and
select a currently most appropriate TDA among the set of TDAs based on results of the evaluating step and one or more conditions that may relate to the input conditions.

20. The TMF apparatus of claim 19, wherein the processing circuitry is further configured to cause the TMF apparatus to:
receive the input conditions to be associated with a specific TDA feedback measurement and/or evaluation; and
repeat the above steps.

21. (canceled)

22. A non-transitory computer readable medium having code stored thereon, the code, when executed, causing a processor to:
configure a set of Time Distribution Alternatives, TDAs;
transmit, to an end station or a Timing Device, TD, a set of report requests with respect to the set of TDAs;
receive, from the end station or from the TD, a set of measurement reports with respect to the set of TDAs, each of the set of measurement reports being specific to a TDA from the set of TDAs and includes corresponding input conditions;
evaluate the set of TDAs based one or more requirements and the set of measurement reports; and
select a currently most appropriate TDA among the set of TDAs based on results of the evaluating step and one or more conditions that may relate to the input conditions.
